(19) United States
(12) Patent Application Publication
(10) Pub. No.: US 2023/0300207 A1
(43) Pub. Date: Sep. 21, 2023

(54) METHOD AND SYSTEM FOR PROVIDING AGGREGATED STATUS AND HEALTH OF NETWORKING ELEMENTS

(71) Applicant: ADAPDIX CORPORATION, Pleasanton, CA (US)

(72) Inventors: David John MOSTO, Dublin, CA (US); Scott KAWAGUCHI, San Jose, CA (US); Jeffrey KNAPP, San Francisco, CA (US); Michael MARSHALL, Emmaus, PA (US); Munene KIRUJA, Valencia, CA (US); Christopher TRINIDAD, Hayward, CA (US)

(73) Assignee: ADAPDIX CORPORATION, Pleasanton, CA (US)

(21) Appl. No.: 18/107,953

(22) Filed: Feb. 9, 2023

Related U.S. Application Data
(60) Provisional application No. 63/308,472, filed on Feb. 9, 2022.

(51) Int. Cl. H04L 67/51

(52) U.S. Cl. CPC H04L 67/51

(57) ABSTRACT

Methods for operating an edge computing unit in a network for data aggregation and status communication with respect to microservices includes extracting data from data sources and converting the extracted data into a pre-defined data set. Data of the pre-defined data set is aggregated into one or more classes based on a prediction performed through a machine learning inferencing or a work flow engine. An irregularity of operation pertaining to the microservices within the aggregated data is identified based on a predetermined-criteria. An alert pertaining to the detected irregularity is generated and communicated to a client device.

### FIELD OF THE INVENTION

The embodiments discussed in the present disclosure are generally related to networking systems. In particular, the embodiments discussed are related to monitoring of a system to provide an aggregated status with respect to multiple disconnected software lifecycles based on machine learning.

### BACKGROUND OF THE INVENTION

Entities execute millions of transactions throughout each day. Each executed transaction is recorded and stored in order to accurately preserve the executed transaction. These transactions are typically recorded and logged. For example, microservices that manage the flow of data routing and the Machine Learning models executing upon that data in a computing/networking environment have any number of connections and dependencies during startup and runtime. Such diversified microservices and technologies correspond to distributed services for being stand-alone and yet being inter-dependent.

Such diversified microservices and technologies report statuses and events as part of providing “monitoring headless system” based functionality. As a part of said functionality, a distributed test device or module is co-located with network components, software modules, or other convenient access points. Distributed test devices/modules monitor the components, software modules, or access points, and report the results of the monitoring. In an instance, such monitoring may report data corruption, anomalies, failures etc. at the component side/module side or the access point.

However, such reporting of statuses/events as a part of headless system monitoring is restricted to the respective architectures of the microservices. In an example, the microservices operate exclusively and do not share the reports amongst each other.

There lies at least a need to aggregate and collate these statuses and events into a unified reporting mechanism that allows an entity such as a human being or a virtual operator to look from a singular perspective on a current health of an entire ecosystem encompassing the microservices. Such capability at least enables an immediate detection as to where failures and errors occur. More specifically, there lies a need for such aggregation, collation, and detection irrespective of a data flow associated with the microservices that may be potentially at speeds faster than human processing.

While cloud-architecture based environments exist in state of the systems that may be leveraged to cater to one or more of aforesaid needs, such architectures serve as globally scaled monitoring services so as to perform monitoring for such services that are dispersed globally or geographically separated. For example, cloud based architectures provide in-built plugins to integrate several different existing services and thereby stream metrics from existing systems to a cloud monitoring platform.

However, the cloud based architectures prove overly expensive and overqualified for low level networking architectures such as an in-house network or local area networks (LAN). Within the cloud based architectures, most existing services are utilized in multi-region environments that need a holistic view and support to understand how their systems are performing. On the other hand, low level networking architectures are required to monitor a system that is not even separated by local firewalls and accessible without any internet connection.

### SUMMARY OF THE INVENTION

Embodiments of a method, a corresponding apparatus, and a corresponding system are disclosed that address at least some of the above-challenges and issues.

### BRIEF DESCRIPTION OF THE DRAWINGS

Further advantages of the invention will become apparent by reference to the detailed description of preferred embodiments when considered in conjunction with the drawings:

FIG. 1 illustrates an exemplary equipment setup according to an embodiment of the present disclosure.

FIG. 2 illustrates a method according to an embodiment of the present disclosure.

FIG. 3 illustrates an edge computing system implementation according to an embodiment of the present disclosure.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown but is to be accorded the widest possible scope consistent with the principles and features disclosed herein.

Certain terms and phrases have been used throughout the disclosure and will have the following meanings in the context of the ongoing disclosure.

A “network” may refer to a series of nodes or network elements that are interconnected via communication paths. In an example, the network may include any number of software and/or hardware elements coupled to each other to establish the communication paths and route data/traffic via the established communication paths. In accordance with the embodiments of the present disclosure, the network may include, but are not limited to, the Internet, a local area network (LAN), a wide area network (WAN), an Internet of things (IOT) network, and/or a wireless network. Further, in accordance with the embodiments of the present disclosure, the network may comprise, but is not limited to, copper transmission cables, optical transmission fibers, wireless transmission, routers, firewalls, switches, gateway computers, and/or edge servers.

A “device” may refer to an apparatus using electrical, mechanical, thermal, etc., power and having several parts, each with a definite function and together performing a particular task. In accordance with the embodiments of the present disclosure, a device may include, but is not limited to, one or more IOT devices. Further, one or more IOT devices may be related, but are not limited to, connected appliances, smart home security systems, autonomous farming equipment, wearable health monitors, smart factory equipment, wireless inventory trackers, ultra-high speed wireless internet, biometric cybersecurity scanners, and shipping container and logistics tracking.

The term “device” in some embodiments, may be referred to as equipment or machine without departing from the scope of the ongoing description.

“On-premises” may refer to the software and technology located within the physical confines of a network. An on-premises device may include, but is not limited to, a device located within the physical confines of a network. In accordance with the embodiments of the present disclosure, the term “on-premises” may be used interchangeably with the terms “site,” “office,” or “floor.”

A “processor” may include a module that performs the methods described in accordance with the embodiments of the present disclosure. The module of the processor may be programmed into the integrated circuits of the processor, or loaded in memory, storage device, or network, or combinations thereof.

A “microservice” may refer to an application as a collection of distributed services that are fine-grained and have protocols that are lightweight.

“Machine learning” may refer to as study of computer algorithms that may improve automatically through experience and by the use of data. Machine learning algorithms build a model based at least on sample data, known as “training data,” in order to make predictions or decisions without being explicitly programmed to do so. Machine learning algorithms are used in a wide variety of applications, such as in medicine, email filtering, speech recognition, and computer vision, where it is difficult or unfeasible to develop conventional algorithms to perform the needed tasks.

In machine learning, a common task is the study and construction of algorithms that can learn from and make predictions on data. Such algorithms function by making data-driven predictions or decisions, through building a mathematical model from input data. These input data used to build the model are usually divided in multiple data sets. In particular, three data sets are commonly used in various stages of the creation of the model: training, validation, and test sets.

The model is initially fit on a “training data set,” which is a set of examples used to fit the parameters of the model. The model is trained on the training data set using a supervised learning method. The model is run with the training data set and produces a result, which is then compared with a target, for each input vector in the training data set. Based at least on the result of the comparison and the specific learning algorithm being used, the parameters of the model are adjusted. The model fitting can include both variable selection and parameter estimation.

Successively, the fitted model is used to predict the responses for the observations in a second data set called the “validation data set.” The validation data set provides an unbiased evaluation of a model fit on the training data set while tuning the model's hyperparameters. Finally, the “test data set” is a data set used to provide an unbiased evaluation of a final model fit on the training data set.

“Deep learning” may refer to a family of machine learning models composed of multiple layers of neural networks, having high expressive power and providing state-of-the-art accuracy.

“Database” may refer to an organized collection of structured information, or data, typically stored electronically in a computer system.

“A headless system” may be a computer system or device that has been configured to operate without a monitor (the missing “head”), keyboard, and mouse. A headless system may be controlled over a network connection or a serial connection.

“Edge computing” may be a distributed computing paradigm that brings computation and data storage closer to the sources of data.

“Work flow engine” may manage and monitor the state of activities in a work flow, such as, for example, the processing and approval of a loan application form, and may determine which new activity to transition to according to defined processes or work flows.

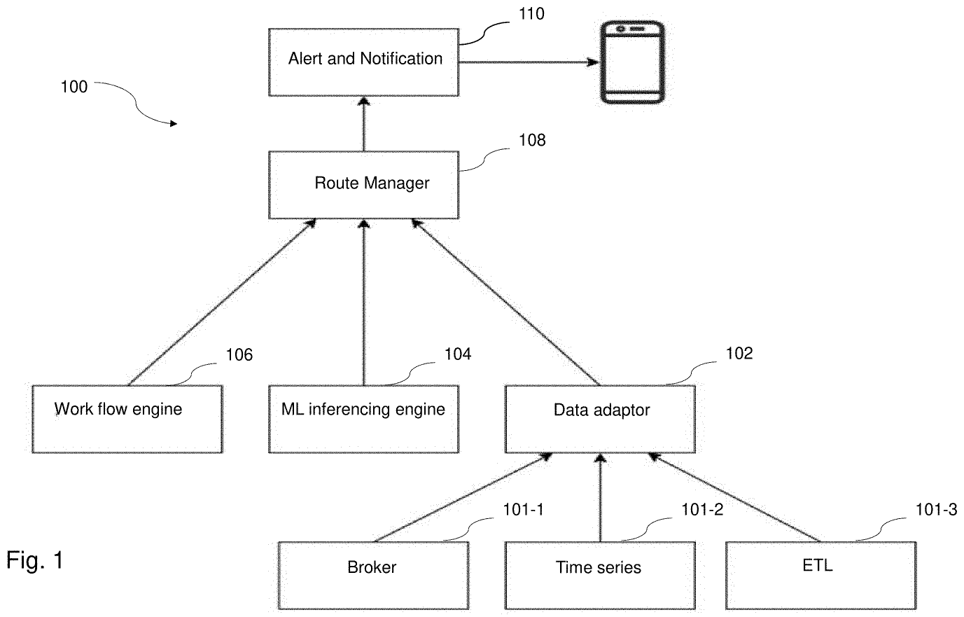

The embodiments of methods, apparatuses, and systems are described in more detail with reference to FIGS. 1-3.

FIG. 1 illustrates an exemplary equipment setup 100 used to manage the status and health of multiple disconnected software lifecycles. The equipment setup 100 may operate based on machine learning and data engineering, and may manage the status and health of multiple disconnected software lifecycles into a single unified view of system health on an “edge computing system.” The equipment setup 100 may include a data adaptor 102, a machine learning (ML) module (ML inferencing engine) 104, a work flow engine 106, a route manager 108, and an alert/notification output 110. The data adaptor 102 may be connected to a variety of data sources 101 associated with microservices such as time series data, ETL, and/or broker. These microservices and the equipment setup 100 may be collocated. Both of them may operate within a same local area network (LAN), and may be connected wirelessly or through wired connection. The equipment setup 100 may be configured to operate as an edge node or an edge computing system such as a data router within the network.

In operation, an intelligent data adaptor 102 may receive data from data sources 101 for conversion into a data set or data format suitable for enabling later, an ML inferencing. In an example, a broker 101-1 may ensure that communication between different microservices is reliable and stable so that messages are managed and monitored within the system, and they do not get lost. In another example, the data may be time series data 101-2 from a data source and generated from microservices. In yet another example, ETL tools 101-3 may be provided to store, stream, and deliver data pertaining to microservices in real time.

Further, a route manager (a date route manager) 108 such as a router is provided that may be configured to execute the ML inferencing engine 104 and the work flow engine 106 to draw prediction over the data received from the data sources 101, and thereby gather statuses and events spanning across diverse architectures of the microservices. Accordingly, the data route manager 108 may employ a criteria defined by the ML inferencing engine 104 and the work flow engine 106, to aggregate these statuses and events into a unified reporting mechanism. Accordingly, the data route manager 108 may operate as a centralized entity or aggregator to single handedly gather information on the current health of the entire ecosystem, when data flowing within the network could potentially be at speeds faster than human processing.

Further, the data route manager 108 by virtue of its data aggregation capability may be able to diagnose and detect where failures and errors occur irrespective of the speed of data flow among microservices and accordingly, may act as a headless monitoring system. The monitoring results obtained by the data route manager 108 may be communicated as alerts or notifications from the edge node 100 to a client device such as a smartphone operating within the local network.

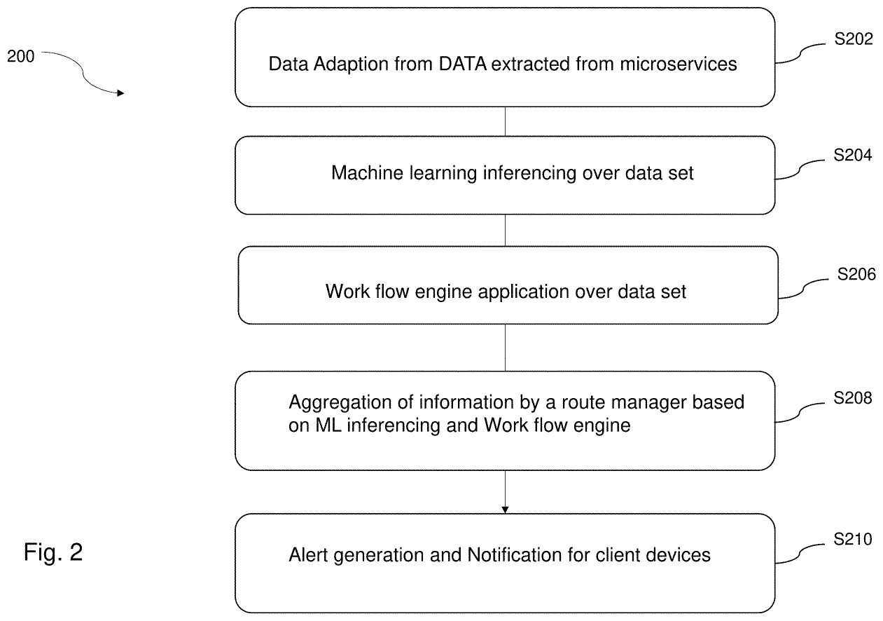

FIG. 2 illustrates a method according to an embodiment of the present disclosure. Specifically, FIG. 2 illustrates an exemplary flowchart illustrating the steps involved in data adaption, inferencing, aggregation, and notification/alert generation by an edge computing system in a networking architecture. FIG. 2 discusses various operations of a method 200 performed by an exemplary equipment setup 100 illustrated in FIG. 1.

Referring to FIG. 2, in step 202, data may be gathered by the data adaptor 102 from diverse data sources 101-1, 101-2, and 101-3, spanning across the microservices as operating within the networking environment.

In step 204, the ML inferencing engine 104 may process the data gathered in step 202 to draw inferences in real time. In an example, the inferencing may include, but is not limited to, feature determination, classification, label generation, and prediction.

In step 206, the work flow engine 106 may operate over the data gathered in step 202 in accordance with state of the art techniques.

In step 208, the route manager 108 may aggregate information regarding the data flow across the microservices based on steps 204 and 206, and thereby detects errors, data corruption, anomalies in accordance with a pre-defined criterion to act as a headless monitoring system for microservices. In other words, data may be monitored as it goes through an ecosystem even if data flows at a rate faster than human cognition. In an example, state of the art Data Quality of Service (QOS) and Data Management module based computer instructions may be provided in the route manager 108 to ensure quality of data. As a part of state of the art technologies, the Data Management module may flag, or notify about missing data, and can quantify the performance of a data stream in real time. The Data Management module may advantageously benefit the route manager 108 by ensuring data quality which is of utmost importance to ML algorithms. Accordingly, the execution of ML algorithms as a part of route manager functionality may be facilitated.

At step 210, alerts and notifications may be generated as a part of headless monitoring performed in step 208 for communication to a local client device such as a smartphone.

Accordingly, at least by virtue of aforesaid and to name a few, the present disclosure enables technology agnostic reporting of metrics and statuses, headless system monitoring, a round the clock monitoring of data flow and processing through a system without disruption, and an ability to monitor data as it goes through an ecosystem faster than human cognition. Overall, the present disclosure enables monitoring potentially headless systems that need close scrutiny and report failures with precision during runtime, while data flows over the local network even at a rate faster than human cognition.

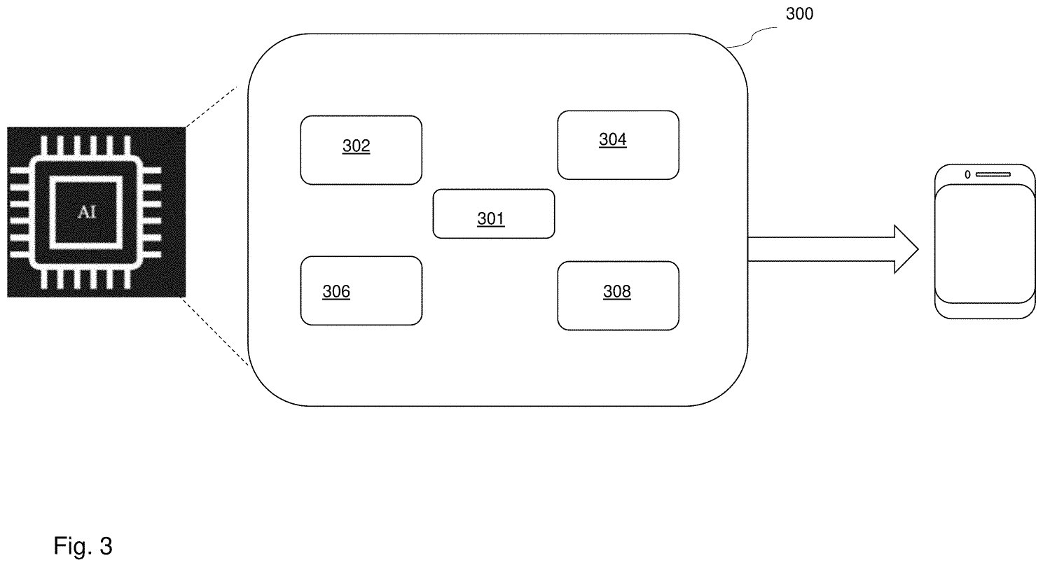

FIG. 3 illustrates an example ML based real time aggregation and reporting system at an edge location in accordance with the embodiments of the present disclosure. FIG. 3 depicts an edge device 300 which represents the device 100 of FIG. 1, which may be at an edge location of a device in accordance with the embodiments of the present disclosure. The term “device edge” may be replaced by the term “equipment edge” without departing from the scope of the present disclosure. The edge device 100 may be a device at a location that is close to a source of data generation such that response times are ultra-low (milliseconds), and bandwidth and cost of handling data is optimal.

In an embodiment of the present disclosure, the edge device 300 may access disparate data sources (such as broker, time series, and ETL as associated with microservices) using machine learning computer instructions at the edge device 300 for inference, storage, display, processing real time adaptive control instructions, and executing instructions for feedback and alert generation.

The edge device 300 may comprise one or more processors that in turn may include different modules 302, 304, 306, and 308 that are functionally equivalent to the modules 102, 104, 106, and 108 of the device 100, respectively, and not explained here for sake of brevity. The modules may be used for example to detect and alert about an abnormal event in the device and for prediction analysis in order to extract information from the data and use it to predict trends and behavior patterns. Similarly, the one or more processors may include any other modules that may have any suitable data operation capability.

The edge device 300 may be part of a larger computer system and/or may be operatively coupled to a computer network (a “network”) with the aid of a communication interface to facilitate transmission of and sharing of data and predictive results. The computer network may be a local area network, an intranet and/or extranet, an intranet and/or extranet that is in communication with the Internet, or the Internet. The computer network in some cases is a telecommunication and/or a data network, and may include one or more computer servers. The computer network, in some cases with the aid of a computer system, may implement a peer-to-peer network, which may enable devices coupled to the computer system to behave as a client or a server.

The edge device 300 may also include memory or memory locations (e.g., random-access memory, read-only memory, flash memory), electronic storage units (e.g., hard disks) communication interfaces (e.g., network adaptors) for communicating with one or more other systems, and peripheral devices, such as cache, other memory, data storage, and/or electronic display adaptors.

The one or more processors e.g., a CPU, execute a sequence of machine-readable instructions, which are embodied in a program (or software). The instructions are stored in a memory location. The instructions are directed to the CPU, which subsequently program or otherwise configure the CPU to implement the methods of the present disclosure. Examples of operations performed by the CPU include fetch, decode, execute, and write back. The CPU may be part of a circuit, such as an integrated circuit. One or more other components of the system may be included in the circuit. In some cases, the circuit is an application specific integrated circuit (ASIC).

The edge device 300 also comprises one or more IO Managers as software instructions that may run on the one or more processors and implement various communication protocols such as User Datagram Protocol (UDP), MODBUS, MQTT, OPC UA, SECS/GEM, Profinet, or any other protocol, to access data in real time from disparate data sources via any communication network, such as Ethernet, Wi-Fi, Universal Serial Bus (USB), ZIGBEE, Cellular or 5G connectivity, etc., or indirectly through a device's primary controller, through a Programmable Logic Controller (PLC) or through a Data Acquisition System (DAQ), or any other such mechanism.

In accordance with the present disclosure, the notification and alerts are sounded by the device 300 based on anomaly detection which is the identification of rare items, events, or observations which raise suspicions by differing significantly from the baseline of the data. Predictive Analysis encompasses a variety of statistical techniques from data mining, predictive modelling, and machine learning, which analyze current and historical facts to make predictions about future or otherwise unknown events. Anomaly detection can detect and alert about an abnormal event in the device 300, and predictive analysis can predict failure well in advance. However, these alerts and predictions still require manual intervention and a lag in fixing the issue resulting in yield reduction and/or part failures.

In accordance with an embodiment of the present disclosure, the anomaly detection is done by looking at historical data and identifying trends in the data that are undesirable. As an example, the data may consistently vary around some mean value, say 0, but if the mean starts to shift upward (resulting in a ramp away from 0 over time), a machine learning model may pick this up and flag the pattern as being an anomaly. This information can then be used as a basis for informing a user of a potential issue with the device 300.

In accordance with an embodiment of the present disclosure, machine learning model training may happen at the edge, close to the data source, or on any remote computer. In certain embodiments, the mathematical representations of the machine learning model training details are stored in memory close to the source of input data. Disparate relevant data streams are fed in memory to a machine learning runtime engine running on the device 300 close to the data source in order to get low latency inferencing. In an embodiment of the present disclosure, inferencing from the machine learning models may happen in real time at an ultra-low frequency of 5 to 30 ms. Further, the inferences and results from the machine learning algorithms are validated for proper behavior and improvements. The device 300 actuates the desired parameters and results of the changes are fed to the run-time engine to validate improvements or do further changes, thereby achieving improvements.

Communication between the device 300 and a client device may be via a communication network such as local area network (LAN), a general wide area network (WAN), and/or a public network (e.g., the Internet, Wi-Fi, 5G) via network adaptor etc.

In an embodiment, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

The terms “comprising,” “including,” and “having,” as used in the claim and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition, or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures, and techniques other than those specifically described herein can be applied to the practice of the invention as broadly disclosed herein without resort to undue experimentation. All art-known functional equivalents of methods, devices, device elements, materials, procedures, and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation. Additionally, it should be understood that the various embodiments of the networks, devices, and/or modules described herein contain optional features that can be individually or together applied to any other embodiment shown or contemplated here to be mixed and matched with the features of such networks, devices, and/or modules.

While the invention has been described with respect to a limited number of embodiments, those skilled in the art, having benefit of this disclosure, will appreciate that other embodiments can be devised which do not depart from the scope of the invention as disclosed herein.

1. A method of operation of an edge computing unit in a network for data aggregation and status communication with respect to microservices, the method comprising:
extracting data from a plurality of data sources and converting the extracted data into a pre-defined data set;
aggregating data from the pre-defined data set into one or more classes based on a prediction performed through at least one of a machine learning (ML) inferencing and a work flow engine;
detecting at least one irregularity of operation pertaining to the microservices within the aggregated data based on a predetermined-criteria; and
generating an alert pertaining to the detected at least one irregularity for communicating to a client device.

2. The method as claimed in claim 1, wherein the aggregated data from the pre-defined data set comprises:
extracting statuses and events from the extracted data; and
collating the extracted statuses and events into a unified report.

3. The method as claimed in claim 1, wherein the detecting comprises reporting failures with precision during runtime while data flows across the microservices.

4. The method as claimed in claim 1, further comprising:
communicating the alert to a local device wirelessly within the network.

5. The method as claimed in claim 1, further comprising:
enabling a display of a centralized view of a health with respect to the microservices by communicating the aggregated data to the client device.
